(19) United States
(12) Patent Application Publication
(10) Pub. No.: US 2016/0009527 A1
(43) Pub. Date: Jan. 14, 2016

(54) WALL WITH STIFFENER INTEGRALLY FORMED THEREIN

(71) Applicant: OTIS ELEVATOR COMPANY, Farmington, CT (US)

(72) Inventor: Zheng Yu, Unionville, CT (US)

(21) Appl. No.: 14/770,393

(22) PCT Filed: Feb. 26, 2013
(86) PCT No.: PCT/US2013/027796

§ 371 Date: Aug. 25, 2015

(51) Int. Cl. B66B 11/02

(52) U.S. Cl. CPC B66B 11/0226; B66B 11/0206

(57) ABSTRACT

A wall having a stiffener integrally formed therein is provided. The stiffener includes a first side panel that extends from the wall, a second side panel that extends from the wall, and an intermediate panel that extends between the first side panel and the second side panel. The first and second side panels and the intermediate panel at least substantially enclose a cavity there between. A method for integrally forming the stiffener in the wall includes the steps of: (a) providing the wall; (b) forming the wall to provide the first and second side panels and the intermediate panel of the stiffener; and (c) bending at least one of the first and second side panels and the intermediate panel of the stiffener so that they at least substantially enclose a cavity there between.

### BACKGROUND

1. Technical Field

Aspects of the present invention generally relate to a wall, and more particularly relate to a wall with a stiffener integrally formed therein.

2. Background Information

It is known to attach a stiffener to a wall (e.g., a wall of sheet metal) to reduce deflection of the wall. The step of attaching the stiffener to the wall can be labor intensive, and can cause damage to the wall. To overcome these and other problems, it would be desirable to provide a wall with a stiffener integrally formed therein.

### SUMMARY

According to an aspect of the present invention, a wall having a stiffener integrally formed therein is provided. The stiffener includes a first side panel that extends from the wall, a second side panel that extends from the wall, and an intermediate panel that extends between the first side panel and the second side panel. The first and second side panels and the intermediate panel at least substantially enclose a cavity there between.

According to another aspect of the present invention, an elevator car wall having a stiffener integrally formed therein is provided. The stiffener includes a first side panel that extends from the wall, a second side panel that extends from the wall, and an intermediate panel that extends between the first side panel and the second side panel. The first and second side panels and the intermediate panel at least substantially enclose a cavity there between.

According to another aspect of the present invention, a method for integrally forming a stiffener into a wall is provided. The method includes the steps of: (a) providing the wall; (b) forming the wall to provide a first side panel, a second side panel, and an intermediate panel of the stiffener, wherein the first side panel and the second side panel extend from the wall, and wherein the intermediate panel extends between the first side panel and the second side panel; and (c) bending at least one of the first side panel, the second side panel, and the intermediate panel of the stiffener so that the first and second side panels and the intermediate panel at least substantially enclose a cavity there between.

According to another aspect of the present invention, a stiffener that forms a unitary structure with a wall is provided. The stiffener includes a first side panel, a second side panel, and an intermediate panel. The first side panel has a base portion that extends from the wall, and a distal portion connected to the intermediate panel. The second side panel has a base portion that extends from the wall, and a distal portion connected to the intermediate panel. The base portion of the first side panel and the base portion of the second side panel are in close proximity to one another.

These and other aspects of the present invention will become apparent in light of the drawings and detailed description provided below.

### BRIEF DESCRIPTION OF THE DRAWINGS

FIG. 1 illustrates a wall with a stiffener.

FIG. 2 illustrates a sectional view of the wall of FIG. 1.

FIG. 3 illustrates a sectional view of another wall with a stiffener.

FIG. 4 illustrates a sectional view of another wall with a stiffener.

FIG. 5 illustrates a sectional view of another wall with a stiffener.

FIG. 6 illustrates another wall with a stiffener.

FIG. 7 illustrates a method for manufacturing the wall of FIG. 3.

FIG. 8 illustrates a sectional view of a prior art elevator car.

### DETAILED DESCRIPTION

The present disclosure describes embodiments of a wall 10 with a stiffener 12 integrally formed therein. The phrase “integrally formed therein” is used herein relative to the wall 10 and the stiffener 12 to describe that the wall 10 and the stiffener 12 are one unitary structure; the wall 10 and the stiffener 12 are not separate structures that are attached together.

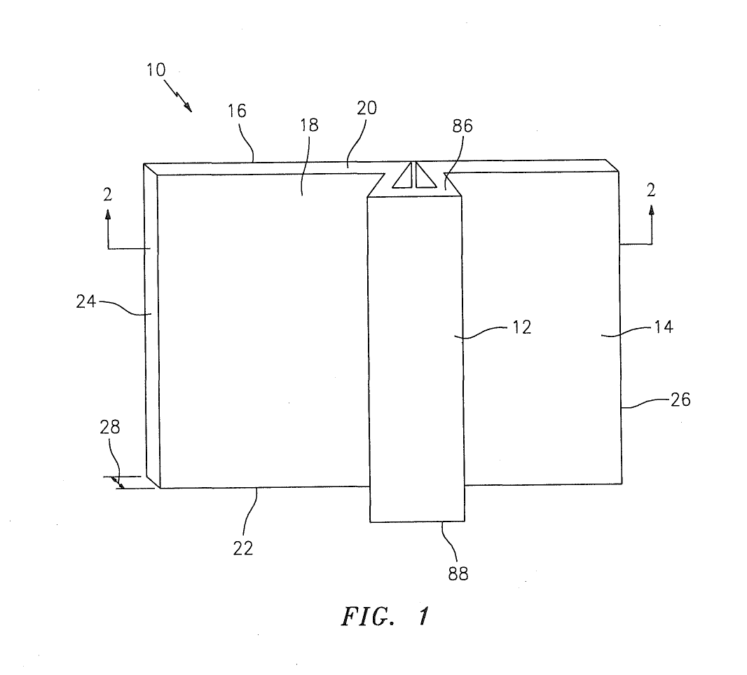

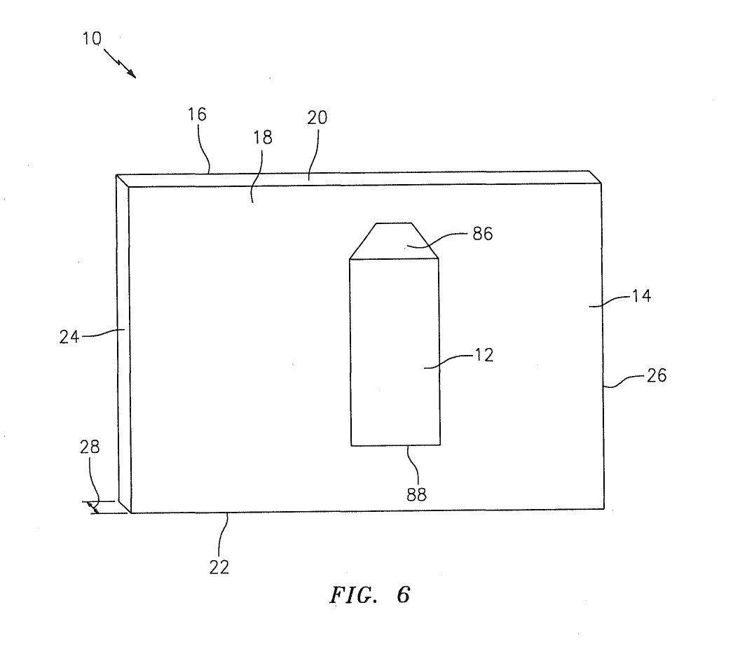

The wall 10 has opposing face surfaces 16, 18 and a plurality of end surfaces 20, 22, 24, 26. In FIGS. 1 and 6, for example, the wall 10 has a first face surface 16, a second face surface 18, a top end surface 20, a bottom end surface 22, a first side end surface 24, and a second side end surface 26. The wall 10 is not limited to any particular size, shape, or material. In FIGS. 1 and 6, the wall 10 is generally rectilinearly shaped, the wall 10 has a thickness 28 extending between the opposing face surfaces 16, 18 that is equal to approximately two millimeters (2 mm), and the wall 10 is made of aluminum. In other embodiments, the wall 10 may be non-rectilinearly shaped, the wall 10 may have another thickness 28 that may preferably be less than approximately 10 millimeters (10 mm), and the wall 10 may be made of another material (e.g., steel, stainless steel, metal alloys, etc.) that is capable of being formed and bent as described below.

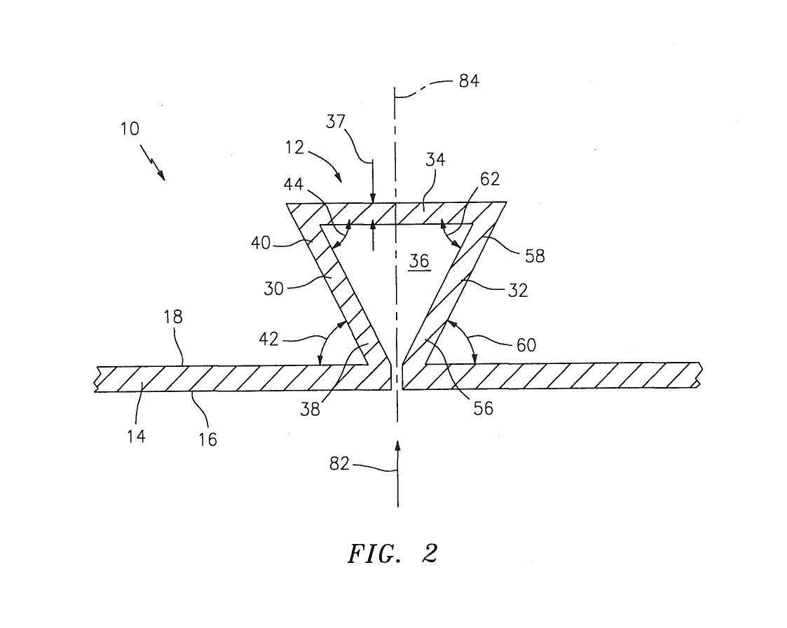

Referring to FIGS. 2-5, the stiffener 12 includes a first side panel 30, a second side panel 32, an intermediate panel 34, and a cavity 36. The first and second side panels 30, 32 extend from the wall 10. The intermediate panel 34 extends between the first and second side panels 30, 32. The first and second side panels 30, 32 and the intermediate panel 34 at least substantially enclose a cavity 36 there between. The stiffener 12 has a thickness 37 that generally may be substantially equal to the thickness 28 of the wall 10.

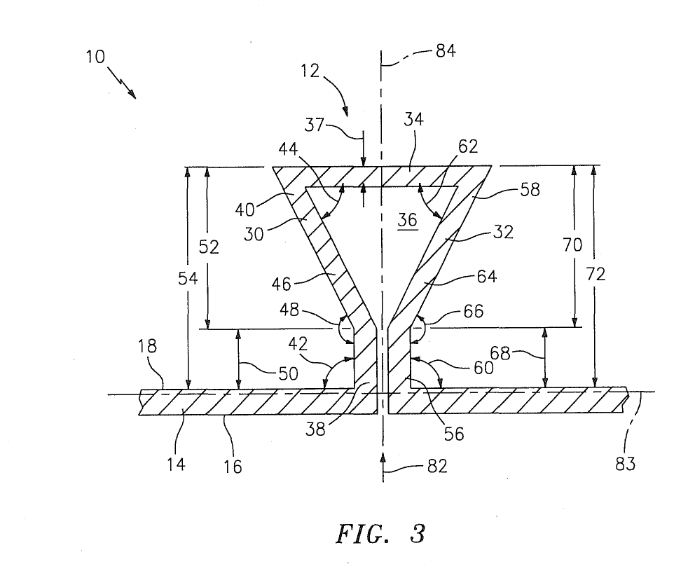

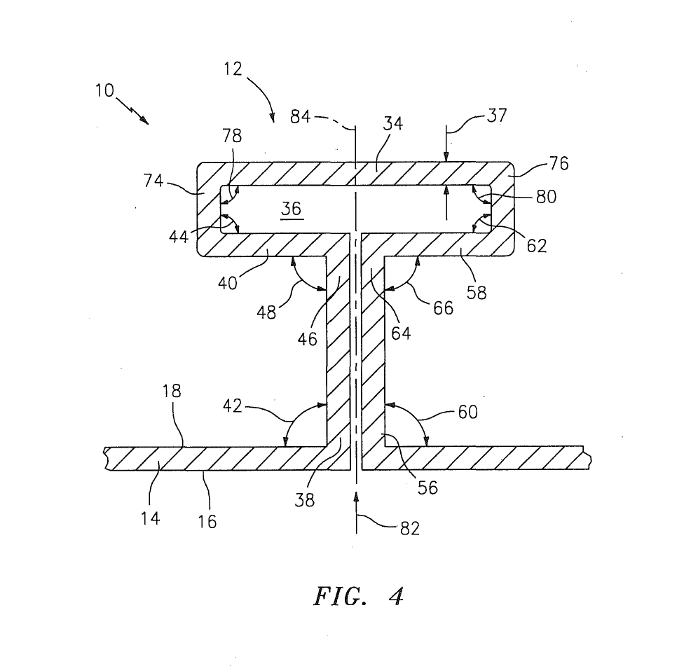

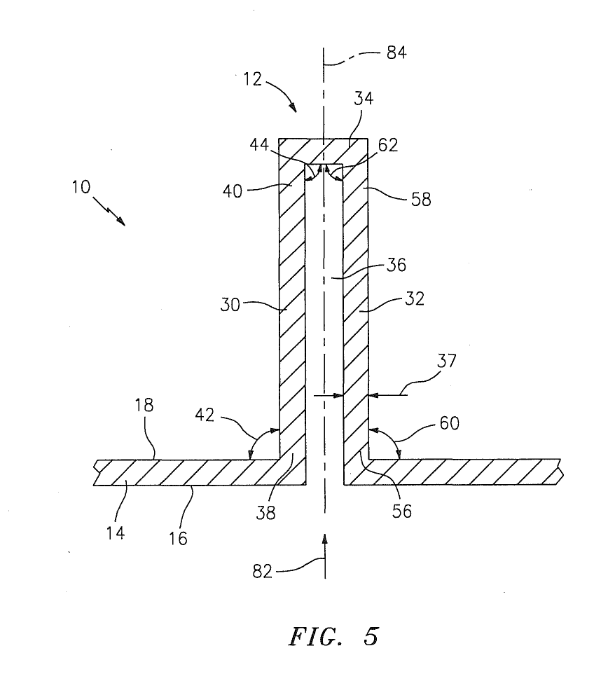

The first side panel 30 of the stiffener 12 includes a base portion 38 and a distal portion 40. The base portion 38 of the first side panel 30 extends from the wall 10. The distal portion 40 of the first side panel 30 is connected to the intermediate panel 34 of the stiffener 12. The base portion 38 of the first side panel 30 and the wall 10 define an angle 42 that is between zero degrees (0°) and one hundred forty-five degrees (145°). In FIG. 2, for example, the angle 42 is approximately forty-five degrees (45°). In FIGS. 3-5, the angle 42 is approximately ninety degrees (90°). The distal portion 40 of the first side panel 30 and the intermediate panel 34 define an angle 44 that is between zero degrees (0°) and one hundred forty-five degrees (145°). In FIGS. 2 and 3, for example, the angle 44 is approximately forty-five degrees (45°). In FIGS. 4 and 5, the angle 44 is approximately ninety degrees (90°). Although the base portion 38 and the distal portion 40 are shown in the drawings as being generally planar, they are not limited to planar configurations; e.g., in some embodiments, one or both of the base portion 38 and the distal portion 40 may be at least partially arcuately shaped, or otherwise shaped. In some embodiments, the first side panel 30 of the stiffener 12 may include a bent portion 46 extending between the base portion 38 and the distal portion 40. The bent portion 46 may define an angle 48 that is between zero degrees (0°) and one hundred eighty degrees (180°). In FIG. 3, for example, the first side panel 30 includes a bent portion 46 that defines an angle 48 that is approximately one hundred twenty degrees (120°). In FIG. 4, the first side panel 30 includes a bent portion 46 that defines an angle 48 that is approximately ninety degrees (90°). The first side panel 30 may be characterized by a base portion height 50, a distal portion height 52, and/or a total height 54 (see FIG. 3). The base portion height 50 is the maximum heightwise distance that the base portion 38 of the first side panel 30 extends away from the wall 10. The distal portion height 52 is the maximum heightwise distance that the distal portion 40 of the first side panel 30 extends away from the wall 10. The total height 54 of the first side panel 30 is the sum of the base portion height 50 and the distal portion height 52. The total height 54 of the first side panel 30 may preferably be within the range of approximately ten millimeters (10 mm) to fifty millimeters (50 mm).

The second side panel 32 of the stiffener 12 includes a base portion 56 and a distal portion 58. The base portion 56 of the second side panel 32 extends from the wall 10. The distal portion 58 of the second side panel 32 is connected to the intermediate panel 34 of the stiffener 12. The base portion 56 of the second side panel 32 and the wall 10 define an angle 60 that is between zero degrees (0°) and one hundred forty-five degrees (145°). In FIG. 2, for example, the angle 60 is approximately forty-five degrees (45°). In FIGS. 3-5, the angle 60 is approximately ninety degrees (90°). The distal portion 58 of the second side panel 32 and the intermediate panel 34 define an angle 62 that is between zero degrees (0°) and one hundred forty-five degrees (145°). In FIGS. 2 and 3, for example, the angle 62 is approximately forty-five degrees (45°). In FIGS. 4 and 5, the angle 62 is approximately ninety degrees (90°). Although the base portion 56 and the distal portion 58 are shown in the drawings as being generally planar, they are not limited to planar configurations; e.g., in some embodiments, one or both of the base portion 56 and the distal portion 58 may be at least partially arcuately shaped, or otherwise shaped. In some embodiments, the second side panel 32 of the stiffener 12 may include a bent portion 64 extending between the base portion 56 and the distal portion 58. The bent portion 64 may define an angle 66 that is between zero degrees (0°) and one hundred eighty degrees (180°). In FIG. 3, for example, the second side panel 32 includes a bent portion 64 that defines an angle 66 that is approximately one hundred twenty degrees (120°). In FIG. 4, the second side panel 32 includes a bent portion 64 that defines an angle 66 that is approximately ninety degrees (90°). The second side panel 32 may be characterized by a base portion height 68, a distal portion height 70, and/or a total height 72 (see FIG. 3). The base portion height 68 is the maximum heightwise distance that the base portion 56 of the second side panel 32 extends away from the wall 10. The distal portion height 70 is the maximum heightwise distance that the distal portion 58 of the second side panel 32 extends away from the wall 10. The total height 72 of the second side panel 32 is the sum of the base portion height 68 and the distal portion height 70. The total height 72 of the second side panel 32 may preferably be within the range of approximately ten millimeters (10 mm) to fifty millimeters (50 mm).

The intermediate panel 34 may be generally planar, as shown for example in the embodiments of FIGS. 2, 3, and 5, or the intermediate panel 34 may be at least partially arcuately shaped, or otherwise shaped. In some embodiments, the intermediate panel 34 of the stiffener 12 may include a bent portion 74, 76. The bent portion 74, 76 may define an angle 78, 80 that is between zero degrees (0°) and one hundred forty-five degrees (145°). In FIG. 4, for example, the intermediate panel 34 includes two (2) bent portions 74, 76 that define two (2) angles 78, 80, respectively. In FIG. 4, the angles 78, 80 both are approximately ninety degrees (90°).

The cavity 36 is a void that is enclosed or substantially enclosed by the first and second side panels 30, 32 and the intermediate panel 34. The term “enclosed” is used herein relative to the cavity 36 to describe embodiments in which the first and second side panels 30, 32 are touching one another. The term “substantially enclosed” is used herein relative to the cavity 36 to describe embodiments in which the first and second side panels 30, 32 are in close proximity to one another. In the embodiments illustrated in FIGS. 1-5, the cavity 36 is substantially enclosed by the first and second side panels 30, 32 and the intermediate panel 34. In the embodiments illustrated in FIGS. 1-5, the cavity 36 is not enclosed by the first and second side panels 30, 32 and the intermediate panel 34, because the first and second side panels 30, 32 are not touching; a small gap 82 extends between the first and second side panels 30, 32. The cavity 36 need not have any particular size; e.g., in embodiments such as the one illustrated in FIG. 5, the cavity 36 may be relatively small.

The stiffener 12, or a portion of the stiffener 12, may be sized and/or shaped so that the stiffener 12 has a desired stiffness characteristic (e.g., a desired area moment of inertia). Referring to the embodiment illustrated in FIG. 3, for example, the stiffener 12 may have an area moment of inertia (I) relative to the axis 83 that is characterized by the following equation:

$${I}_{x} \approx \frac{2}{3} {h}^{3} t - \frac{2}{3} \frac{( {H}^{3} - {h}^{3} ) t}{cos \partial } - \frac{sin \partial }{cos \partial } {( H - \frac{t}{2} )}^{2} [ 2 ( H - h ) - t ) ] t$$

where h is the base portion height 50 of the first side panel 30 or the base portion height 68 of the second side panel 32; His the total height 50 of the first side panel 30 or the total height 72 of the second side panel 32; t is the thickness 37 of the stiffener 12; and a is the angle 48 of the bent portion 46 of the first side panel 30 or the angle 66 of the bent portion 64 of the second side panel. Based on the equation above, the area moment of inertia (I) is most sensitive to changes in the dimension H.

In some embodiments, including the embodiments illustrated in FIGS. 1-5, the first and second side panels 30, 32 and the intermediate panel 34 may be sized and shaped so that the stiffener 12 is generally symmetrical about an axis 84 (see FIGS. 2-5) that extends generally perpendicular to a plane defined by the wall 10. In other embodiments, the first and second side panels 30, 32 and the intermediate panel 34 may be sized and shaped so that the stiffener 12 is not symmetrical. In some embodiments, the first and second side panels 30, 32 may be attached to one another, for example using a mechanical fastener, welding techniques, or other acceptable means or methods. In some embodiments, the first and second side panels 30, 32 and the intermediate panel 34 may be sized and shaped to facilitate attachment of the first and second side panels 30, 32. In FIGS. 3-5, for example, the base portions 38, 56 of the first and second side panels 30, 32 extend generally parallel to one another, thereby facilitating attachment of the first and second side panels 30, 32.

In some embodiments, the stiffener 12 may extend from an end surface 20, 22, 24, 26 of the wall 10. In FIG. 1, for example, the stiffener 12 extends from the top end surface 20 to the bottom end surface 22 of the wall 10. In FIG. 1, a top end surface 86 of the stiffener 12 is coplanar with the top end surface 20 of the wall 10, and a bottom end surface 88 of the stiffener 12 is coplanar with the bottom end surface 22 of the wall 10. In other embodiments, the stiffener 12 may not extend from an end surface 20, 22, 24, 26 of the wall 10. In FIG. 6, for example, the stiffener 12 does not extend from either the top end surface 20 or the bottom end surface 22 of the wall 10. In FIG. 6, the top end surface 86 of the stiffener 12 is not coplanar with the top end surface 20 of the wall 10, and the bottom end surface 88 of the stiffener 12 is in coplanar with a bottom end surface 22 of the wall 10.

In some embodiments, a structure that is separate from the wall 10 and the stiffener 12 may be positioned between the first and second side panel 30, 32 of the stiffener 12. In one example not shown in the drawings, a decorative panel having a locating member extending there from may be positioned relative to the wall 10. The locating member of the decorative panel may extend through the gap 82 between the first and second panels 30, 32 to aid in positioning the decorative panel relative to the wall 10. In some embodiments, the locating member of the decorative panel may extend into the cavity 36 of the stiffener 12.

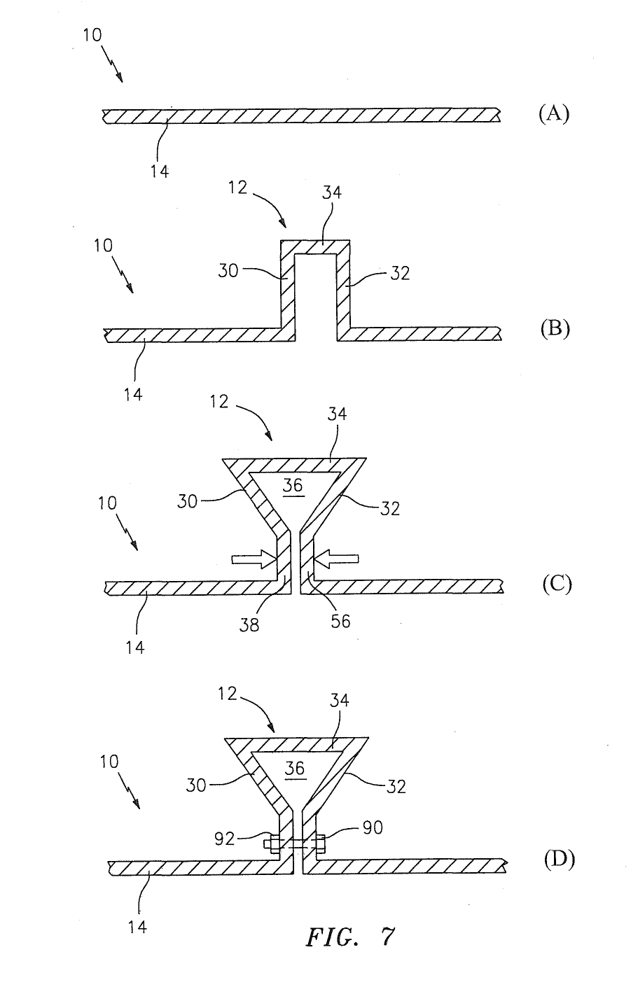

The stiffener 12 can be integrally formed in the wall 10 in many different ways. Referring to FIG. 7, one acceptable method for integrally forming the stiffener 12 in the wall 10 includes the steps of: (a) providing the wall 10; and (b) forming the wall 10 (e.g., using a punch press) to provide the first and second side panels 30, 32 and the intermediate panel 34 of the stiffener 12; and (c) bending the first side panel 30, the second side panel 32, and/or the intermediate panel 34 so that the first and second side panels 30, 32 and the intermediate panel 34 at least substantially encloses the cavity 36 there between. In FIG. 7, this third step (i.e., step (c)) is performed by biasing (e.g., using a clamp) the base portion 38 of the first side panel 30 and the base portion 56 of the second side panel 32 towards one another. Some methods for integrally forming the stiffener 12 in the wall 10 include the additional step of attaching the first and second side panels 30, 32 to one another. In FIG. 7, this optional fourth step (i.e., step (d)) is performed by bolting the first and second side panels 30, 32 together using a bolt 90 and a nut 92.

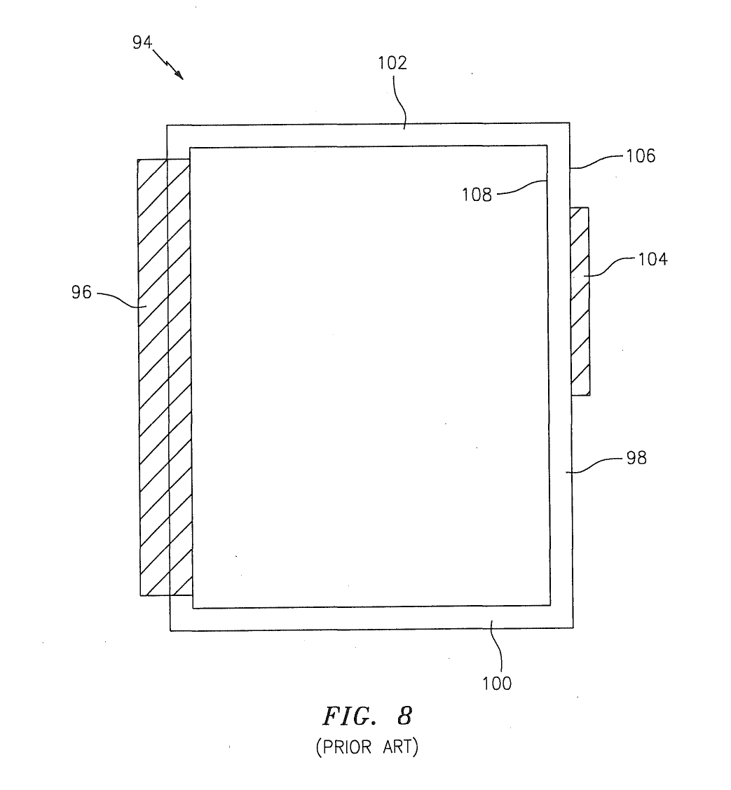

The wall 10 with the stiffener 12 integrally formed therein can be used in many applications. The wall 10 may be particularly useful, for example, in applications that require a wall that is both stiff and lightweight. The wall 10 may be useful, for example, in elevator cars, or other transport cars (e.g., rail cars). Referring to FIG. 8, for example, a prior art elevator car 94 includes a door 96, a sidewall 98, a floor 100, and a ceiling 102. A prior art stiffener 104 is attached to the external surface 106 of the sidewall 98; the prior art stiffener 104 is not integrally formed in the sidewall 98. The step of attaching the prior art stiffener 104 to the sidewall 98 may be labor intensive. The prior art stiffener 104 may undesirably add weight to the elevator car 94. The prior art stiffener 104 typically may be attached to the sidewall 98 using spot welding or glue. If spot welding is used, a burn mark may be visible on the interior surface 108 of the sidewall 98. It may be necessary, therefore, to refinish or cover (e.g., with decorative paneling) the interior surface 108 of sidewall 98. If glue is used, the prior art stiffener 104 may lose contact with the sidewall 98 over time as a result of certain environmental conditions, such as high humidity or temperature. It may be necessary, therefore, to reattach the prior art stiffener 104 to the sidewall 98. To avoid these and other problems, it may be advantageous to replace the sidewall 98 and prior art stiffener 104 with the present wall 10 with the stiffener 12 integrally formed therein. The present wall 10 with the stiffener 12 may be just as stiff as, if not stiffer than, the sidewall 98 and the prior art stiffener 104. The present wall 10 with the stiffener 12 may be lighter than the sidewall 98 and the prior art stiffener 104. The present wall 10 with the stiffener 12 may be easier to manufacture and install than the sidewall 98 and the prior art stiffener 104; e.g., the step of attaching the prior art stiffener 104 to the sidewall 98 can be eliminated, the need to refinish or cover the interior surface of sidewall 98 can be eliminated, etc.

While various embodiments of the present invention have been disclosed, it will be apparent to those of ordinary skill in the art that many more embodiments and implementations are possible within the scope of the invention. Accordingly, the present invention is not to be restricted except in light of the attached claims and their equivalents.

What is claimed is:

1. A wall having a stiffener integrally formed therein, the stiffener comprising:
a first side panel that extends from the wall;
a second side panel that extends from the wall; and
an intermediate panel that extends between the first side panel and the second side panel;
wherein the first and second side panels and the intermediate panel at least substantially enclose a cavity there between.

2. The wall of claim 1, wherein the first side panel of the stiffener includes a base portion and a distal portion, wherein the base portion extends from the wall, and wherein the distal portion is connected to the intermediate panel of the stiffener.

3. The wall of claim 2, wherein base portion of the first side panel and the wall define an angle between 0° and 145°.

4. The wall of claim 2, wherein the distal portion of the first side panel and the intermediate panel define an angle between 0° and 145°.

5. The wall of claim 2, wherein the first side panel of the stiffener further includes a bent portion extending between the base portion and the distal portion, wherein the bent portion defines an angle between 0° and 180°.

6. The wall of claim 1, wherein the first side panel has a total height between 10 mm and 50 mm.

7. The wall of claim 1, wherein the second side panel of the stiffener includes a base portion and a distal portion, wherein the base portion extends from the wall, and wherein the distal portion is connected to the intermediate panel of the stiffener.

8. The wall of claim 2, wherein the base portion of the second side panel and the wall define an angle between 0° and 145°.

9. The wall of claim 2, wherein the distal portion of the second side panel and the intermediate panel define an angle between 0° and 145°.

10. The wall of claim 2, wherein the second side panel of the stiffener further includes a bent portion extending between the base portion and the distal portion, wherein the bent portion defines an angle between 0° and 180°.

11. The wall of claim 1, wherein the second side panel has a total height between 10 mm and 50 mm.

12. The wall of claim 1, wherein the first side panel of the stiffener includes a base portion that extends from the wall;
wherein the second side panel of the stiffener includes a base portion that extends from the wall; and
wherein the base portion of the first side panel extends generally parallel to the base portion of the second side panel.

13. The wall of claim 1, wherein the first side panel of the stiffener includes a base portion that extends from the wall;
wherein the second side panel of the stiffener includes a base portion that extends from the wall; and
wherein the base portion of the first side panel is in close proximity to the base portion of the second side panel.

14. The wall of claim 1, wherein the first side panel of the stiffener includes a base portion that extends from the wall;
wherein the second side panel of the stiffener includes a base portion that extends from the wall; and
wherein the base portion of the first side panel is in contact with the base portion of the second side panel.

15. The wall of claim 1, wherein the intermediate panel includes a bent portion that defines an angle between 0° and 145°.

16. The wall of claim 1, wherein the first and second side panels and the intermediate panel enclose the cavity there between.

17. The wall of claim 1, wherein the first and second side panels and the intermediate panel substantially enclose the cavity there between.

18. The wall of claim 1, wherein a gap extends between the first and second side panels.

19. The wall of claim 1, wherein the stiffener is generally symmetrical about an axis that extends generally perpendicular to a plane defined by the wall.

20. An elevator car wall having a stiffener integrally formed therein, the stiffener comprising:
a first side panel that extends from the wall;
a second side panel that extends from the wall; and
an intermediate panel that extends between the first side panel and the second side panel;
wherein the first and second side panels and the intermediate panel at least substantially enclose a cavity there between.

21. A method for integrally forming a stiffener into a wall, comprising the steps of:
providing the wall;
forming the wall to provide a first side panel, a second side panel, and an intermediate panel of the stiffener, wherein the first side panel and the second side panel extend from the wall, and wherein the intermediate panel extends between the first side panel and the second side panel.
bending at least one of the first side panel, the second side panel, and the intermediate panel of the stiffener so that the first and second side panels and the intermediate panel at least substantially enclose a cavity there between.

22. The method of claim 21, further comprising the step of attaching the first side panel to the second side panel.

23. A stiffener that forms a unitary structure with a wall, the stiffener comprising:
a first side panel having a base portion that extends from the wall, and a distal portion connected to an intermediate panel;
a second side panel having a base portion that extends from the wall, and a distal portion connected to the intermediate panel; and
wherein the base portion of the first side panel and the base portion of the second side panel are in close proximity to one another.
